(19) United States
(12) Patent Application Publication
(10) Pub. No.: US 2018/0230324 A1
(43) Pub. Date: Aug. 16, 2018

(54) Flooring Coating Formulation And Floor Covering Having Wear Layer Formed With Same

(71) Applicant: Mannington Mills, Inc., Salem, NJ (US)

(72) Inventors: Joshua Lensbouer, Salem, NJ (US); Brian Kuritz, Salem, NJ (US)

(21) Appl. No.: 15/891,390

(22) Filed: Feb. 8, 2018

Related U.S. Application Data
(60) Provisional application No. 62/458,737, filed on Feb. 14, 2017.

(51) Int. Cl. C09D 133/08; C09D 1/02; C08K 3/22; C08K 3/36; C08F 20/06; C08F 20/22; C08G 18/67; B32B 27/30; B32B 27/32; E04F 15/024; E04F 15/04; E04F 15/10

(52) U.S. Cl. CPC C09D 133/08; B32B 2471/00; C08K 3/22; C08K 3/36; C08F 20/06; C08F 20/22; C08G 18/672; B32B 27/304; B32B 27/308; B32B 27/32; E04F 15/02405; E04F 15/04; E04F 15/107; C08K 2003/2227; C08K 2201/005; B32B 2305/72; B32B 2307/408; B32B 2307/536; C09D 1/02

(57) ABSTRACT

A flooring coating formulation is disclosed that contains inorganic particles, at least one crosslinking acrylate monomer, at least one polymerizable cyclic/aromatic acrylate monomer, matting agent particles, at least one reactive diluent acrylate monomer, at least one fluorinated acrylate monomer, at least one crosslinkable oligomer, and at least one photoinitiator. The inorganic particles, such as aluminum oxide, can be present in the coating in an amount sufficient to improve wear and/or stain resistance. A floor covering that includes a layer of cured coating which has a polymerized formulation of the flooring coating formulation also is disclosed.

### BACKGROUND OF THE INVENTION

This application claims the benefit under 35 U.S.C. § 119(e) of prior U.S. Provisional Patent Application No. 62/458,737, filed Feb. 14, 2017, which is incorporated in its entirety by reference herein.

The present invention relates to a flooring coating formulation and a floor covering which incorporates the formulation into a wear layer thereof

Present floor coverings, such as resilient flooring or vinyl floor tiles/panels, can contain a support surface or core, a wear surface, and a wear layer top coat. The top coat is subjected to foot traffic and wear from carts and other heavy objects coming in contact with the wear layer top coat. As a result, the top coat deteriorates leading to the exposure of lower layers of the floor such as the wear layer base coat, a print layer, or even the support or core surface. When the lower layers are exposed and subjected to the environment including foot traffic and other objects, the floor becomes unsightly (e.g., dirty, difficult to clean, and susceptible to stains) and can also be partially or completely destroyed. While efforts have been made to create more surface coverings, especially in the flooring industry, such efforts have not totally solved the problem of making the wear layer top coat more resilient to the environment to which it is subjected. Efforts to make the top coat more resilient have included radiation curable urethane topcoat, waterbase urethane, acrylic, or melamine coatings and the like. Efforts to improve wear in surface coverings also have involved incorporation of aluminum oxide therein, such as shown, e.g., in U.S. Pat. Nos. 6,218,001, 6,291,078 and 7,384,697, which are all incorporated in their entireties by reference herein.

Even with these developments, there is still a need for further improvement in floor coverings to provide flooring with more resistance to wear and staining while maintaining other needed flooring properties and environmental-friendliness.

### SUMMARY OF THE INVENTION

A feature of the present invention is to provide flooring coating formulation which is curable to form a wear and/or stain resistant layer.

Another feature of the present invention is to provide a wear layer that can provide more resistance to wear and staining while providing other required flooring properties, such as with regard to hardness/resiliency, gloss and so forth, and which uses environmentally-friendly production methods and materials (e.g., low VOC (volatile organic compound) emissions).

A further feature of the present invention is to provide a floor covering which has a wear and/or stain resistant layer formed of a cured coating of the flooring coating formulation.

An additional feature of the present invention is to provide a floor covering that is vinyl composition tile, vinyl flooring, vinyl resilient flooring, plastic panels, wood panels, veneer-board panels, composite panels with or without a print layer, which has the wear and/or stain resistant layer, rubber flooring, or PVC free type flooring.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a flooring coating formulation which comprises a) inorganic particles, b) at least one crosslinking acrylate monomer, c) at least one polymerizable cyclic/aromatic acrylate monomer, d) matting agent particles which are different from a), e) at least one reactive diluent acrylate monomer, f) at least one fluorinated acrylate monomer, g) at least one crosslinkable oligomer, and h) at least one photoinitiator. As an option, the flooring coating formulation can further include an adhesion promoter and/or other ingredients.

The present invention further relates to a floor covering comprising a layer of cured coating, wherein the cured coating comprises a polymerized formulation of the flooring coating formulation.

It is to be understood that both the foregoing general description and the following detailed description are exemplary and explanatory only and are intended to provide a further explanation of the present invention, as claimed.

The accompanying drawing, which is incorporated in and constitutes a part of this application, illustrate some of the embodiments of the present invention and together with the description, serves to explain the principles of the present invention.

### BRIEF DESCRIPTION OF DRAWING

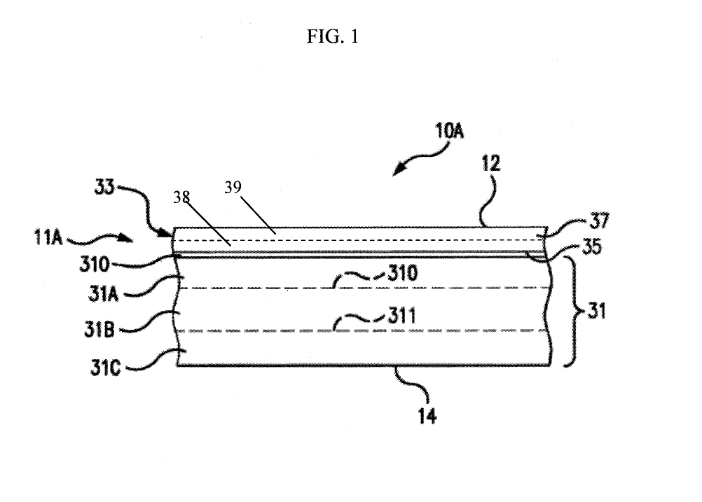

The FIG. 1 is an enlarged cross-sectional view of a flooring plank according to an example of the present application.

### DETAILED DESCRIPTION OF THE PRESENT INVENTION

The present invention relates to a flooring coating formulation which can form a wear layer that provides improved performance with respect to wear resistance, stain resistance, or both. The wear layer can provide these improvements in wear resistance and stain resistance in part, with use of wear resistant inorganic particle content, while providing gloss and hardness/resiliency suitable for flooring. The flooring coating formulation can be a rapid curing, low solvent content coating with low or no VOC (volatile organic compound) emissions when curing. When cured, the flooring coating formulation can capture a high percentage of the original formulation as material crosslinkable into the polymer matrix reaction product, or otherwise as low volatility material surrounded by the coating to become part of the suspended cured matrix. As an option, the flooring coating formulation combines wear resistant inorganic particles with a curable coating system which comprises acrylate monomers and oligomers. The curable coating system can comprise linear and cyclic acrylate/methacrylate monomers and acrylate/methacrylate oligomers having functionalities which result in crosslink formation in the presence of initiator (e.g., UV-curing) or electron energy (e.g., electron beam curing). Additional additives can be included in the coating formulation, such as matting agent particles, which are different from the wear resistant particles. The present invention further relates to a floor covering comprising a layer(s) of cured coating, wherein the cured coating comprises a polymerized formulation of the flooring coating formulation. The floor covering can be vinyl composition tile, vinyl flooring, vinyl resilient flooring, non-vinyl flooring, rubber flooring, hard panels, laminate flooring, plastic panels, wood panels, veneer-board panels, or composite panels with or without a print layer, or other flooring coverings.

The flooring coating formulation of the present invention, as an option, comprises a) wear-resistant inorganic particles, b) at least one crosslinking acrylate monomer, c) at least one polymerizable cyclic/aromatic acrylate monomer, d) matting agent particles which are different from a), e) at least one reactive diluent acrylate monomer, f) at least one fluorinated acrylate monomer, g) at least one crosslinkable oligomer, h) at least one photoinitiator, and optionally i) at least one adhesion promoter.

As an option, the flooring coating formulation contains a) from about 3 wt % to about 18 wt % of the inorganic particles, b) from about 2 wt % to about 20 wt % of the at least one crosslinking acrylate monomer, c) from about 2 wt % to about 20 wt % of the at least one polymerizable cyclic/aromatic acrylate monomer, d) from about 2 wt % to about 8 wt % of the matting agent particles which are different from a), e) from about 2 wt % to about 20 wt % of the at least one reactive diluent monomer, f) from about 0.5 wt % to about 4 wt % of the at least one fluorinated acrylate monomer, g) from about 6 wt % to about 48 wt % of the at least one crosslinkable oligomer, and h) from about 2 wt % to about 10 wt % of the at least one photoinitiator, all based on total weight of the flooring coating formulation.

The flooring coating formulation can contain a) from about 5 wt % to about 16 wt % of the inorganic particles, b) from about 3 wt % to about 16 wt % of the at least one crosslinking acrylate monomer, c) from about 5 wt % to about 19 wt % of the at least one polymerizable cyclic/aromatic acrylate monomer, d) from about 3 wt % to about 7 wt % of the matting agent particles which are different from a), e) from about 5 wt % to about 19 wt % of the at least one reactive diluent monomer, f) from about 0.75 wt % to about 3 wt % of the at least one fluorinated acrylate monomer, g) from about 10 wt % to about 40 wt % of the at least one crosslinkable oligomer, and h) from about 3 wt % to about 8 wt % of the at least one photoinitiator, all based on total weight of the flooring coating formulation.

As an option, from about 70 wt % to about 90 wt %, or from about 75 wt % to about 85 wt %, or from about 79 wt % to about 81 wt % of the flooring coating formulation is crosslinkable into a matrix formed when curing the flooring coating formulation to form a cured coating therefrom, based on total weight of the flooring coating formulation. The remaining amount of the original coating formulation can either break down and gas off, or become surrounded or trapped by the cured coating (and for instance by the crosslinked network) and become part of the matrix. For example, about 80 wt % of the flooring coating formulation can be crosslinkable into a matrix formed when curing the flooring coating formulation to form a cured coating therefrom, and the remaining about 20% amount of the original formulation can either break down and gas off, or become surrounded or trapped by the cured coating and become part of the matrix. The crosslinked proportions of the flooring coating formulation in the cured coating can be the same as or essentially the same as the indicated percentages for the crosslinkable portions of the uncured formulation (e.g., from about 70 wt % to about 90 wt %, or from about 69 wt % to about 89 wt %, or other values), based on total weight of the flooring coating formulation.

The wear-resistant inorganic particles of the flooring coating formulation can comprise mineral particles, glass particles, or other inorganic material particles, or any combination thereof As an option, the wear-resistant inorganic particles can be aluminum oxide, feldspar, fused silica, or recycled ground glass, or other inorganic particles, or any combination thereof The wear-resistant inorganic particles, such as aluminum oxide, can comprise from about 3 wt % to about 18 wt %, or from about 5 wt % to about 16 wt %, or from about 7 wt % to about 13 wt %, or other concentrations, based on total weight of the flooring coating formulation. Unless stated otherwise, references herein to the total weight of the flooring coating formulation refer to the wet uncured formulation.

As a preferred option, the wear-resistant inorganic particles are aluminum oxide. The aluminum oxide that can be used in the present invention is also known as alumina or Al₂O₃. Preferably, the aluminum oxide is fused or calcined. The refractive index is preferably from about 1.4 to about 1.7. Generally, a sufficient amount of the aluminum oxide is present in at least one layer of a floor covering, such as a wear layer at or near the top surface thereof, to provide improved wear and/or stain resistance to a floor covering as compared to no aluminum oxide being present.

Wear resistance can be determined by a Taber abrasion test, a Gardner scrubber test, a walk test and the like. The Taber abrasion test is more commonly used in the flooring industry. One way to determine stain resistance is by staining the sample with different stain amounts and removing the stain after about 1 to 5 hours with solvents. The stain remaining on the sample rated on a scale from 0 to 3, where 0 means no stain showing and 3 means the darkest, visible stain showing.

Any source of aluminum oxide can be used. It is preferred that the aluminum oxide have the following characteristics: fused or calcined and having a hardness of from about 6 to about 9 on a Moh's scale, and most preferably about 9 on a Moh's scale.

The average particle size of the wear-resistant inorganic particles, such as aluminum oxide, as an option, can be from about 10 microns to about to about 60 microns, preferably from about 15 microns to about 50 microns, more preferably about 16 to about 40 microns, or other sizes. Sources for aluminum oxide are Washington Mills, N. Grafton, Mass.; ALCOA Industrial Chemicals, Bauxite, Ark.; Composition Materials, Fairfield, Conn.; Micro Abrasives, Westfield, Mass.; Alu Chem, Inc., Birmingham, Ala. and Panadyne, of Montgomeryville, Pa.

If the particles are uniformly suspended in the coating at a fixed coating thickness and weight of wear-resistant inorganic particles, such as alumina, the abrasion resistance usually will increase as the particle size is increased. Similarly, at a given coating thickness and particle size, the abrasion resistance usually will be governed by the weight or concentration of particles in the coating. The particle size of wear-resistant inorganic particles, such as alumina is generally proportional to the wear resistance of the coating at a constant coating thickness and fixed amount of particles. In the same way, at a fixed coating thickness and particle size of wear-resistant inorganic particles, such as alumina, the wear resistance of the cured coating is directly related to the weight of the particles incorporated in the coating. The particle size of the wear-resistant inorganic particles, such as alumina, is preferably equal to or higher (preferably from 10-60% higher) than the coating thickness in order to achieve high wear resistance. When the hard particles such as alumina protrude above the coating, these hard particles protect the coating from abrading. This method gives very high abrasion resistance to the product. However, when the particles are exposed or not covered by the coating, the particles may act as dirt catchers. Thus, depending on the end use of the product, the coating thickness, the particle size, and the amount of particles should be suitably selected.

As a preferred option, the wear-resistant inorganic particles used in the flooring coating formulation can include a mixture of at least three different size fractions thereof, which differ with respect to average particle size by at least 3 microns from each other. This is especially effective for particles like aluminum oxide or fused aluminum oxide. This can provide scratch protection from the use of larger sized particles, surface abrasion control from use of smaller sized particles, and intermediate sized particles can be provided for balancing these characteristics. As an option in this respect, the wear-resistant inorganic particles, such as aluminum oxide, such as fused aluminum oxide can be used in the flooring coating formulation as a mixture of a first size fraction of particles having an average particle size of from 16 to 20 microns, a second size fraction of particles having an average particle size of from 23 to 27 microns, and a third size fraction of fused aluminum oxide particles having an average particle size of from 33 to 37 microns. A specific example can be, e.g., aluminum oxide used in the flooring coating formulation as a mixture of a first size fraction of fused aluminum oxide particles having an average particle size of about 18 microns, a second size fraction of fused aluminum oxide particles having an average particle size of about 25 microns, and a third size fraction of fused aluminum oxide particles having an average particle size of about 35 microns. When particles such as aluminum oxide are used in such different sized fractions, the flooring coating formulation can contain from about 1 wt % to about 6 wt %, or from about 2 to about 4 wt %, such as about 2 wt %, or other concentrations, of each the three different fractions of the particles, based on total weight of the flooring coating formulation.

As an example, from about 2 g/m² to about 50 g/m², such as from about 4 g/m² to about 20 g/m² of wear-resistant inorganic particles, such as alumina, can be present in at least one layer of the floor covering. The particles can be added in any manner known to those skilled in the art for adding particles to a layer. The wear-resistant inorganic particles, such as aluminum oxide can be mixed into a wet coating or scattered on top of a wet coating. For premixed, the wear-resistant inorganic particles, such as aluminum oxide may be introduced during addition of other coating ingredients with good mixing, or introduced at the end of mixing of the other ingredients and shortly before coating the formulation. The mixing of alumina (and/or other hard inorganic particles) with a formulation that forms the wet coating generally requires constant mixing of the coating with wear-resistant inorganic particles, such as alumina to preferably keep the alumina suspended in the coating. Surface treatments of the wear-resistant inorganic particles, such as alumina and/or the use of other anti-settling agents may help in minimizing the settling. However, suspending high concentrations of wear-resistant inorganic particles, such as aluminum oxide in acrylates or other types of coatings for a long period of time can be problematic due to possible settling of the inorganic particles. For the scattering option, the wear-resistant inorganic particles, such as aluminum oxide may be applied by a pellet dispenser which applies or sprinkles wear-resistant inorganic particles, such as aluminum oxide on top of a layer which is still “wet” or uncured, and then curing the wet coating with the wear-resistant inorganic particles, such as alumina sprinkled thereon. By the layer being “wet” or uncured, the wear-resistant inorganic particles, such as aluminum oxide “sticks” or adheres to the “wet” layer and at least a portion of the wear-resistant inorganic particles, such as aluminum oxide “sinks” into the layer and thus is not exposed to the environment.

Several types of scattering machines can be used to accomplish the uniform sprinkling or dispensing of wear-resistant inorganic particles, such as alumina or other hard particles. Normally the scattering machine has rotating, dispensing or applicator roll (engraved or knurled) at the bottom of the hopper. A stationary or rotary brush is used to remove the material from the dispensing or applicator roll. A shaker screen may be used under the hopper for uniform distribution of wear-resistant inorganic particles, such as alumina oxide or other hard particles. The knurl size, the dispending or applicator roll speed, the brush position, the speed of the rotary brush, and the speed and the size of the shaker screen should all be selected based on the amount and the size of the aluminum oxide to be used. Examples of scattering machines that can be used to dispense aluminum oxide or other hard particles of powder according to the invention are a Christyg 11 machine (Christy Machine Company, Fremont, Ohio, USA) or a Schilling machine (Emil Paul Schilling AG) or similar dispensing equipment.

Another ingredient of the flooring coating formulation of the present invention is the matting agent particles. The matting agent particles, which also can be referred to as flatting agent particles, can reduce the gloss of the coating. The matting agent particles can comprise inorganic particles which differ from those used as the wear-resistant particles in the flooring coating formulation. For instance, the silica can be untreated precipitated silica (e.g., synthetic precipitated amorphous silica), untreated thermal (fused) silica, silica gel, polymer-treated precipitated silica, polymer-treated thermal silica, silica gel containing resin, or other silica or silica-based matting agents. The matting agent particles can be commercially available, such as ACEMATT 3600, ACEMATT 3300, and ACEMATT TS100, ACEMATT 412, ACEMATT 500, and ACEMATT 520 products from Evonik Industries, GENOMER 7287 from Rahn USA Corp., and LO VEL 66, 8100, 2023, 2033, 2010, and 1018 products from PPG, and Syloid 161, 162 C, 7000, C906, RAD 2005 and Syloid 2105 from WR, Grace, Columbia, Md. The matting agent particles preferably are used in an amount effective to provide the matting performance in the coating. The matting agent particles, such as silica or silica-based particles, can be used in an amount of from about 2 wt % to about 8 wt %, or from about 3 wt % to about 7 wt %, or from about 4 wt % to about 6 wt %, or about 4 wt %, or other concentrations, based on total weight of the flooring coating formulation.

As indicated, the flooring coating formulation includes a curable coating system which comprises linear and cyclic acrylate/methacrylate monomers and acrylate/methacrylate oligomers having functionalities which result in crosslink formation when cured. Crosslinking, or curing, is a process during which at least one multifunctional molecule participates in polymerization and is incorporated into polymer chains to form a polymer matrix. For purposes herein, the term “acrylate” can be used generally, wherein it can refer to acrylate or methacrylate, i.e., (meth)acrylate.

The flooring coating formulation of the present invention includes at least one crosslinking acrylate monomer. As an option, the crosslinking acrylate monomer can be trimethylolpropane triacrylate (TMPTA), triethylene glycol diacrylate, tripropylene glycol diacrylate, or 1, 6-hexandiol diacrylate, or other multifunctional (containing more than one reactive group, e.g., 2, 3, 4, 5, 6, or more reactive groups) crosslinking acrylate monomer, or any combination thereof. As an option, the crosslinking acrylate monomer can be trimethylolpropane triacrylate (TMPTA) which is commercially available, such as the SR1351 LV product from Sartomer Arkema Group, Exton, Pa. The crosslinking acrylate monomer preferably can be used in an amount effective to support formation of a three-dimensional crosslinked matrix reaction product. The crosslinking acrylate monomer can increase crosslinking density for better scratch and stain performance and chemical resistance. The crosslinking acrylate monomer can be used in an amount of from about 2 wt % to about 20 wt %, or from about 3 wt % to about 16 wt %, or from about 4 wt % to about 12 wt %, or about 11 wt %, or other concentrations, based on total weight of the flooring coating formulation.

The flooring coating formulation of the present invention includes at least one polymerizable cyclic/aromatic acrylate monomer. The term “cyclic” refers to non-aromatic ring-containing structure (e.g., an aliphatic ring) or an aromatic ring-containing structure (e.g., phenyl). The polymerizable cyclic/aromatic acrylate monomer can be phenylphenoxy ethyl acrylate, isobornyl methacrylate, cyclohexane dimethanol dimethacrylate, or ethoxylated bisphenol diacrylate, or other cyclic/aromatic acrylate monomer, or any combination thereof.

As an option, the polymerizable cyclic/aromatic acrylate monomer may be a monofunctional monomer (containing only one reactive group), such as phenylphenoxy ethyl acrylate and isobornyl methacrylate, which may in part shape the type and nature of a main chain polymer backbone, and which can be aromatic and hydrophobic, and may be used to obtain a desired glass transition temperature, flexibility, mechanical strength, polarity, and/or hydrophobic/hydrophilic character of the resulting polymer.

As another option, the polymerizable cyclic/aromatic acrylate monomer may be a difunctional monomer (containing two reactive groups), such as cyclohexane dimethanol dimethacrylate or ethoxylated bisphenol diacrylate, which may be useful to imparting crosslinking or branching sites to the polymer matrix. As an option, the polymerizable cyclic/aromatic acrylate monomer can be a phenylphenoxy ethyl acrylate, which is commercially available, such as the PHOTOMER 4135 product from IGM Resins. The polymerizable cyclic/aromatic acrylate monomer can be used in an amount of from about 2 wt % to about 20 wt %, or from about 5 wt % to about 19 wt %, or from about 8 wt % to about 18 wt %, or about 18 wt %, or other concentrations, based on total weight of the flooring coating formulation.

The flooring coating formulation of the present invention includes at least one reactive diluent acrylate monomer. The at least one reactive diluent acrylate monomer can be dipropylene glycol diacrylate (DPGDA), isobornyl acrylate, 1,6-hexandiol diacrylate, diethylene glycol diacrylate, 1,4-butanediol diacrylate, tripropylene glycol diacrylate, or diethylene glycol diacrylate, or other reactive diluent monomer, or any combination thereof. The reactive diluent acrylate monomers may be used to lower the viscosity of the uncured coating to facilitate application. Monomer viscosities may range from 5 to 5,000 centipoise or other values. The reactive diluent acrylate monomers are lower in molecular weight than the oligomers used in the flooring coating formulation. As an option, mono- or di-functional reactive diluent acrylate monomers can be used, but monomers having higher functionalities may be used. Monofunctional reactive diluent acrylate monomers typically act as diluents, improve flexibility, and reduce shrinkage. Difunctional reactive diluent acrylate monomers can crosslink and also can act as diluents, increase film tensile strength, enhance chemical resistance, and increase the cure rate. Reactive diluent acrylate monomers, such as the types cited as examples herein, are commercially available. The reactive diluent acrylate monomer can be used in an amount of from about 2 wt % to about 20 wt %, or from about 5 wt % to about 19 wt %, or from about 8 wt % to about 18 wt %, or about 18 wt %, or other concentrations, based on total weight of the flooring coating formulation.

The flooring coating formulation of the present invention includes at least one crosslinkable oligomer. As an option, the oligomers can be higher molecular weight (e.g., 1,000-100,000, weight average MW) crosslinkable coating components, relative to the reactive diluent acrylate monomers. The oligomers can impart physical properties of the finished coating and performance features. The at least one crosslinkable oligomer can be included in the flooring coating formulation in a total amount of from about 6 wt % to about 48 wt %, or from about 10 wt % to about 40 wt %, or from about 15 wt % to about 30 wt %, or other concentrations, based on total weight of the flooring coating formulation. Different types of oligomers, such as different types of acrylate-based oligomers, can be included in the flooring coating formulation to impart specific performance features.

As an option, the at least one crosslinkable oligomer can be a combination of different oligomers which comprises at least one crosslinkable aliphatic urethane acrylate oligomer, at least one crosslinkable polyester acrylate oligomer, and at least one crosslinkable self-matting oligomer. The crosslinkable aliphatic urethane acrylate oligomer can impart chemical and stain resistance, the polyester acrylate oligomer can impart stain resistance, and the at least one crosslinkable self-matting oligomer can be a matting wax oligomer. As a preferred option, the at least one crosslinkable oligomer can comprise at least one crosslinkable aliphatic urethane hexaacrylate oligomer having a functionality of about 6, at least one crosslinkable polyester acrylate oligomer having a functionality of about 3.5, and at least one crosslinkable self-matting oligomer having/comprising a functionality of about 2 or 2. The crosslinkable aliphatic urethane acrylate oligomer can be obtained commercially, such as EBERCRYL 5129, 8311, 265, and 810 products from Allnex, DESMOLUX XP (2683/1 and 2738) products from Allnex, and CN 9026 product from Sartomer Americas. The crosslinkable polyester acrylate can be obtained commercially, such as EBERCRYL 893 product from Allnex, GENOMER 3414 from Rahn USA Corp., DESMOLUX XP 2170 product from Allnex, and CN 2262, 2267, 2270, 2302, and 2304 products from Sartomer Americas. The crosslinkable self-matting oligomer can be obtained commercially, such as GENOMER 7287 from Rahn USA Corp. As an option, from about 2 wt % to about 20 wt % of at least one crosslinkable aliphatic urethane acrylate oligomer, from about 2 wt % to about 20 wt % of at least one crosslinkable polyester acrylate oligomer, and from about 2 wt % to about 8 wt % of at least one crosslinkable self-matting oligomer, can be included in the flooring coating formulation, based on total weight of the flooring coating formulation.

As another option, from about 5 wt % to about 18 wt %, or from about 8 wt % to about 16 wt %, or about 16 wt %, of at least one crosslinkable aliphatic urethane acrylate oligomer, from about 2 wt % to about 20 wt %, or from about 8 wt % to about 16 wt %, or about 16 wt %, of at least one crosslinkable polyester acrylate oligomer, and from about 2 wt % to about 8 wt %, or from about 3 wt % to about 7 wt %, or about 5 wt %, of at least one crosslinkable self-matting oligomer, can be included in the flooring coating formulation, based on total weight of the flooring coating formulation.

The flooring coating composition contains at least one fluorinated acrylate monomer. The fluorinated acrylate polymer can provide polymers with low surface energies, which can enhance cleanability, or provide other performance. As an option, the at least one fluorinated acrylate monomer can be pentafluorophenyl acrylate, or pentafluorophenyl methacrylate, or other fluorinated acrylate monomer, or any combination thereof. The fluorinated acrylate monomer can be obtained commercially, such as PL3105 product from EssTech, Essington, Pa. The flooring coating formulation can contain from about 0.5 wt % to about 4 wt %, or from about 0.75 wt % to about 3 wt %, or from about 1 wt % to about 2 wt %, or about 1 wt %, or other concentrations, of the at least one fluorinated acrylate monomer, based on total weight of the flooring coating formulation.

The flooring coating composition can contain at least one photoinitiator. In UV-cured coating systems, a free radical-generating photoinitiator can be used to initiate crosslinking of the coatings directly on a substrate. The at least one photoinitiator can be methyl-2-benzoylbenzoate, 2-hydroxy-2-methyl-1-phenyl-1propanone, benzyl dimethyl ketal, 1-hydroxy-cyclohexylphenyl-ketone, or methyl benzoyl formate, or other photoinitiator, or any combination thereof. The flooring coating composition can contain from about 2 wt % to about 10 wt %, or from about 3 to about 8 wt %, or from about 4 wt % to about 6 wt %, or about 4 wt %, or other concentrations, of the at least one photoinitiator, all based on total weight of the flooring coating formulation. As another curing option, electron beam (EB) curing can be used wherein the coating is exposed to a stream of electrons, and sufficient energy can be produced from electron bombardment to generate free radical polymerization without an initiator. Both radiation curing methods can provide 100%-reactive, single-component systems, fast cure line speeds, and the ability to coat heat-sensitive substrates.

As a specific option, the flooring coating formulation can comprise a) from about 1 wt % to about 6 wt % of aluminum oxide particles having an average particle size of from 16 to 20 microns, b) from about 1 wt % to about 6 wt % of aluminum oxide particles having an average particle size of from 23 to 27 microns, c) from about 1 wt % to about 6 wt % of aluminum oxide particles having an average particle size of from 33 to 37 microns, d) from about 2 wt % to about 20 wt % of at least one crosslinking acrylate monomer, e) from about 2 wt % to about 20 wt % of at least one polymerizable cyclic/aromatic acrylate monomer, f) from about 2 wt % to about 8 wt % of silica, g) from about 2 wt % to about 20 wt % of at least one reactive diluent acrylate monomer, h) from about 0.5 wt % to about 4 wt % of at least one fluorinated methacrylate monomer, i) from about 2 wt % to about 20 wt % of at least one crosslinkable aliphatic urethane acrylate oligomer, j) from about 2 wt % to about 20 wt % of at least one crosslinkable polyester acrylate oligomer, k) from about 2 wt % to about 8 wt % of at least one crosslinkable self-matting oligomer, and l) from about 2 wt % to about 10 wt % of at least one photoinitiator, all based on total weight of said flooring coating formulation.

As a more specific option, the flooring coating formulation can comprise a) from about 2 wt % to about 4 wt % of aluminum oxide particles having an average particle size of from 16 to 20 microns, b) from about 2 wt % to about 4 wt % of aluminum oxide particles having an average particle size of from 23 to 27 microns, c) from about 2 wt % to about 4 wt % of aluminum oxide particles having an average particle size of from 33 to 37 microns, d) from about 2 wt % to about 20 wt % of at least one crosslinking acrylate monomer, e) from about 3 wt % to about 16 wt % of at least one polymerizable cyclic/aromatic acrylate monomer, f) from about 3 wt % to about 7 wt % of silica, g) from about 5 wt % to about 19 wt % of at least one reactive diluent acrylate monomer, h) from about 0.75 wt % to about 3 wt % of at least one fluorinated methacrylate monomer, i) from about 5 wt % to about 18 wt % of at least one crosslinkable aliphatic urethane acrylate oligomer, j) from about 5 wt % to about 18 wt % of at least one crosslinkable polyester acrylate oligomer, k) from about 3 wt % to about 7 wt % of at least one crosslinkable self-matting oligomer, and l) from about 3 wt % to about 8 wt % of at least one photoinitiator, all based on total weight of said flooring coating formulation.

The flooring coating formulation may further include one or more optional additives, such as an optional adhesion promoter. The adhesion promoter can be acrylic based, as an option, such as hydroxyethyl methacrylate phosphate. If used, the adhesion promoter can be included in the flooring coating formulation in an amount of from about 1 wt % to about 4 wt %, such as about 2 wt %, or other concentrations. With regard to organic solvent content, the flooring coating formulation may contain 0 to 10 wt % VOC, or 0 to 5 wt % VOC, or 0 to 4 wt % VOC, or 0 to 3 wt % VOC, or 0 to 2 wt % VOC, or from 0 to 1 wt % VOC, or other amounts.

The floor covering can be a resilient flooring or vinyl tile/panel which contains a support surface or core. Applied to the top of and adhered to this support surface or core is a wear surface. An intermediate layer(s) such as a strengthening layer may be located between the core and wear layer. The wear surface can contain a wear layer base coat and a wear layer top coat. Also, an initial wear layer can be applied prior to the wear layer base coat which is adhered to the support surface. One or more strengthening layer(s) can also be present and located anywhere in the surface covering. The flooring coating formulation of the present invention can be used in the wear surface, such as in the wear layer top coat, the wear layer base coat, or in both, or in other wear layers.

The coating thickness of the flooring coating formulation for use in a wear layer, and the particle size of alumina (or other wear resistant particles, if used) used therein, can be selected depending on the required wear characteristics, product appearance, and other properties of the finished product such as stain resistance, flexibility, cleanability, aesthetics, and styling requirements. For example, to obtain a smooth-looking product, the coating thickness should be just sufficient to cover the particles when scattered on the wet coating. The other way to accomplish this is to use a multi-layer coat system. In this case, the particles can be uniformly scattered on a wet base coat, and then after a partial, full, or no cure, another layer of top coat is applied on the base coat with or without particles in the top coat. For a smooth coating, the total thickness of the coating (different layers) should be greater than the largest particle size of the wear-resistant particles used. There are several combinations of this type of construction. For example, a construction can be used where the wear-resistant inorganic particles, such as alumina is placed at different locations in the top coat. Another construction would be to sandwich the wear-resistant inorganic particles, such as alumina between two layers of coating. In this type of construction, the curing process is precisely controlled to have intercoat adhesion and other desired properties of the finished product. In still another type of construction, the coating thickness and the particle size of wear-resistant inorganic particles, such as alumina can be chosen in a way that a desired portion of the wear-resistant inorganic particles, such as alumina sinks into the coating and the other part is exposed above the top coat. This gives the product very high wear resistance because the protruding particles offer high wear resistance. Once the wear-resistant inorganic particles, such as aluminum oxide is applied to the layer which is “wet” or uncured, the surface covering containing this layer can be cured by means known to those skilled in the art, such as radiation curing, UV, electron beam, thermal and/or moisture curing, and the like.

In general, the flooring coating of the present invention can have any thickness when formed as a layer on flooring or a flooring substrate. The flooring coating of the present invention can have a thickness (e.g., uniform thickness) of from about 0.5 mil to about 1.5 mil or more, such as from about 0.75 mil to 1.25 mil. This thickness can be the cured thickness or pre-cured thickness of the flooring coating of the present invention.

The aluminum oxide (or other wear resistant particle) can be present in the outermost layer of a floor covering which is the layer subjected to the environment including foot traffic and other objects coming in contact with the floor covering. Generally, this outermost layer is known as the top coat layer or wear layer top coat. For instance, solid vinyl (inlaid) coverings can be coated with 1.0-1.8 mil of UV-curable top coat, or other coating thicknesses using the flooring coating formulation of the present invention. On the wet coat, if not already mixed therein, fused alumina or other wear resistant particle can be applied to this top coat, such as by a scattering machine, and then the top coat can be cured by UV-light employing either a direct or differential cure mechanism. A floor covering wherein aluminum oxide can be applied to a layer is described in U.S. Pat. Nos. 5,458,953, and 5,670,237, which are incorporated in their entireties by reference herein, and the incorporated U.S. Pat. Nos. 6,218,001, 6,291,078 and 7,384,697. The method of preparing this surface covering can also be used in the present invention with the additional step of adding wear-resistant inorganic particles, such as aluminum oxide to one layer incorporated into this method. The flooring of the present invention can optionally be embossed with textures and/or designs, and this embossing can be in register with an optional printed design on the top of the tile surface.

A layer of cured coating formed with the flooring coating formulation of the present invention can have properties suitable for flooring, such as a durometer Shore A hardness reading of from about 80 to about 100. The layer of cured coating can exhibit gloss in a range of from 6 to 14.

As illustrated in FIG. 1, a floor plank (or any flooring surface) 10A of an example of the present invention comprises a sheet 11A, which has significant portions of the top and bottom surfaces 12 and 14 that are generally horizontally planar and extend parallel to each other. For purposes of this example, the plank is constructed of luxury vinyl tile (LVT) material. The sheet 11A comprises at least one base layer (or core) 31, such as three base layers 31A-31C. The hatched lines 310 and 311 indicate original interfaces of the stacked sublayers, which may or may not be visible in the finished laminate, depending in part on the coloring or hues of the various sublayers. The base layer 31 can comprise at least one polymeric material and at least one filler (e.g., inorganic filler). Top layer 33 is formed on base layer 31. Top layer 33 can be a multi-layer structure. The top layer 33 contains the polymerized or cured flooring coating formulation of the present invention in one or more layers thereof. The top layer 33 is integrally attached to an upper surface 310 of the base layer 31. Top layer 33 can comprise a print design 35 and a wear layer or overlay 37. The print design 35 is optional. The print design, if used, may be continuous or non-continuous (e.g., intermittent). As an option, the wear layer 37 can include a bottom coat layer 38 and a top coat layer or an outermost layer 39. As an option, at least the top coat layer or outermost layer 39 contains the polymerized flooring coating formulation of the present invention. The bottom coat layer 38, if used, can comprise polyvinylchloride, urethane, acrylic, melamine, polyolefins, or wood. The bottom coat layer 38, as an option, can be polyvinylchloride, e.g., transparent polyvinylchloride. The top coat layer or outermost layer 39 can be adhered directly onto the bottom coat layer 38, if used, or onto an intermediate wear layer base coat (not shown) adhered on the bottom coat layer 38. The top layer 33 optionally can have an underlay (not shown) below the print design 35 and/or a protective layer (not shown) on the wear layer 37. One or more of the base layers 31A-C can be formed, for example, of LVT-based material, or in other options as vinyl composition tile (VCT)-based material, rubber-based material, or other polymeric materials in combination with filler. Other base layer and intermediate layer structures which may be used are shown in U.S. Pat. No. 5,891,294 and U.S. Patent Application Publication No. 2011/0167744, which are all incorporated in their entirety by reference herein. As an option, at least about 50%, or at least about 60%, or at least about 80%, or at least about 90%, or at least about 95%, of the top and bottom surfaces 12 and 14 of the plank 10A are flat or relatively flat surfaces. As an option, a surface of the sheet 11A can include a textural or embossed surface, wherein the embossed surface can be in register with the print design, and can be achieved mechanically and/or chemically. As an option, the plank can be connected to other planks which have a similar structure, wherein side edges of adjacent planks can be connected together by tongue and groove connections, or a spline, or a snap connector, or other edge connection structure, such as disclosed in U.S. Patent Application Publication Nos. 2012/0040149, 2011/0131916, and 2011/0167744, which are all incorporated in their entireties by reference herein. Further, though illustrated here in an LVT material, a wear layer which incorporates the flooring coating formulation of the present invention can be used in other types of flooring material, such as VCT, WPC, or vinyl flooring, hard flooring, wood flooring, rubber flooring, PVC-free flooring, non-PVC flooring, veneer surface flooring, laminate flooring and the like. The flooring can be in the form of rolls, tile, or planks.

The present invention will be further clarified by the following examples, which are intended to be exemplary of the present invention.

### EXAMPLES

### Example 1

In this Example, several variations of the present invention were tested. A flooring coating formulation of the present invention was prepared using each of the following formulas:

| | Formula 1 | Formula 2 |
|---|---|---|
| Material | (grams) | (grams) |
| oligomer-hexa functional aliphatic urethane | 44 | 43 |
| MW = 800 | | |
| Polyester acrylate oligomer | 48 | 47 |
| Cured Tensile | | |
| Strength of 1422 psi | | |
| Aliphatic oligomer w/nano composite | 18 | 18 |
| Cured Tensile | | |
| Strength of 5000 psi | | |
| Aluminum Oxide Mixture (2 wt % each of | 6 | 6 |
| average size: 18, 25, 35 micron) | | |
| Fused Silica Matting Agent | 18 | 18 |
| Matting Oligomer | 19 | 19 |
| Functionality 2 and Refractive Index of 1.457 | | |
| Type 1 photoinitiator | 5.5 | 5.5 |
| Second generation Benzo | | |
| Hexanediol diacrylate | 60 | 60 |
| Fluorinated Methacrylate | 2 | 4 |
| Total (grams) | 220.5 | 220.5 |

### Mixing Conditions:

1) Liquid components were weighed out into a mixing container from the highest weight to the lowest weight
2) Liquids were blended for 10 minutes using a Cowles blade at 2500 rpm
3) AceMatt was weighed out and added slowly during the blending of step 2
4) After the Acematt was added, the aluminum oxide was weighed out and added to the liquid mixture under mixing conditions for a total of 2 minutes
5) Lastly, the MBB photo initiator was weigh out and added slowly to the mixture from Step 4 under mixing until all MBB was added
6) Mixing continued for an addition 5 minutes after all ingredients were added

### Coating Conditions:

1) Coating was heated to 105 degrees F.
2) Before applying, coating was hand mixed to ensure all materials were suspended
3) Using a 1 mil Bird Bar applicator, Coating was added to Mannington Realities substrate using a standard draw down method.

### Curing Conditions:

1) Material was cured using a 2 lamp system with D bulbs at 28 ft a minute.
2) A total of 1000 mJ A with 1500 mW A was applied to cure the substrate
3) Material was flipped over, placed face down on the belt, and sent through the unit a second time after curing to cure any coating that may have made it to the back or edge of the substrate

### Testing Conditions:

ASTM D4060-14*- Abrasion Resistance of Organic Coatings
   a. Method was modified to use Taber Abrader Model #5135
   b. Testing used a H-18 Taber Wheel
   c. Testing was conducted for 1000 cycles
   d. 2 samples were tested for each formula
   e. Sample was weighed before Testing
   f. Sample was wiped free of coating debris using a paper towel, after testing
   g. Sample was weighed
   h. Weight difference was recorded

### Results of Testing:

| | | Initial | After | Difference | Difference |
|---|---|---|---|---|---|
| | | Wt (g) | Wt. (g) | (g) | (%) |
| Formula | #1-1 | 24.1368 | 24.116 | 0.0208 | 0.0861755 |
| 1 | #1-2 | 24.1911 | 24.176 | 0.0151 | 0.0624197 |
| Formula | #2-1 | 24.1189 | 24.0959 | 0.023 | 0.0953609 |
| 2 | #2-2 | 23.8588 | 23.8342 | 0.0246 | 0.1031066 |

The results show a 0.1 wt % or less change in weight after the test on abrasion resistance for each sample. This is a very small weight percent loss and is reflective of excellent abrasion resistance of the cured coatings of the present invention.

### Example 2: Mini Martindale Testing for Scratch Resistance and Wear Resistance

The coatings of Example 1 were further tested as follows:

### Testing Conditions:

EN16044*-Test Method for Micro Scratching
   a. Method was modified to use Mini-Martindale Abrasion and Pilling Tester model 401
   b. Testing uses 80 grit sand paper
   c. Testing was conducted for 500 cycles
   d. Testing was conducted with a 260 grams weight
   e. Sample was wiped off to remove coating debris with a paper towel
   f. Sample was weighed before testing and after testing
   g. After weighing, a SHARPIE blue marker was used to color in any scratch area (if present)
   h. Isopropanol and paper-towels were used to remove surface marker leaving only the marker in scratched crevices (if present).
      Upon inspection, the cured coatings of the present invention had no blue marker showing, and this means that there were no scratches observed on the coating. This would mean that the coatings of the present invention are scratch and wear resistant. This is further shown in the Table below, where the wt % difference (before/after) were below 0.1 wt %, and actually below 0.05 wt %, which is also reflective of excellent scratch and wear resistance.

| | | Initial Wt | After Wt. | Difference | Difference |
|---|---|---|---|---|---|
| | | (g) | (g) | (g) | (%) |
| Formula 1 | #1-1 | 26.457 | 26.449 | 0.008 | 0.0302377 |
| | #1-2 | 26.6023 | 26.5954 | 0.0069 | 0.0259376 |
| Formula 2 | #2-1 | 26.1126 | 26.1064 | 0.0062 | 0.0237433 |
| | #2-2 | 26.032 | 26.0262 | 0.0058 | 0.0222803 |

The present invention includes the following aspects/embodiments/features in any order and/or in any combination:

1. The present invention relates to a flooring coating formulation, comprising:
a) inorganic particles;
b) at least one crosslinking acrylate monomer;
c) at least one polymerizable cyclic/aromatic acrylate monomer;
d) matting agent particles which are different from a);
e) at least one reactive diluent acrylate monomer;
f) at least one fluorinated acrylate monomer;
g) at least one crosslinkable oligomer; and
h) at least one photoinitiator.
2. The flooring coating formulation of any preceding or following embodiment/feature/aspect, wherein from about 70 wt % to about 90 wt % of the coating formulation is crosslinkable into a matrix upon curing the coating formulation, based on total weight of the coating formulation.
3. The flooring coating formulation of any preceding or following embodiment/feature/aspect, further comprising i) an adhesion promoter.
4. The flooring coating formulation of any preceding or following embodiment/feature/aspect, wherein the inorganic particles comprise aluminum oxide, feldspar, fused silica, or recycled ground glass, or any combination thereof.
5. The flooring coating formulation of any preceding or following embodiment/feature/aspect, wherein the inorganic particles are aluminum oxide.
6. The flooring coating formulation of any preceding or following embodiment/feature/aspect, wherein the aluminum oxide is calcined or fused aluminum oxide.
7. The flooring coating formulation of any preceding or following embodiment/feature/aspect, wherein said aluminum oxide has an average particle size of from about 10 to about 60 microns.
8. The flooring coating formulation of any preceding or following embodiment/feature/aspect, wherein the aluminum oxide is present in an amount sufficient to improve wear and/or stain resistance.
9. The flooring coating formulation of any preceding or following embodiment/feature/aspect, wherein the inorganic particles comprise aluminum oxide as a mixture of at least three different size fractions which differ with respect to average particle size by at least 3 microns from each other.
10. The flooring coating formulation of any preceding or following embodiment/feature/aspect, wherein the inorganic particles comprise aluminum oxide as a mixture of a first size fraction of fused aluminum oxide particles having an average particle size of from 16 to 20 microns, a second size fraction of fused aluminum oxide particles having an average particle size of from 23 to 27 microns, and a third size fraction of fused aluminum oxide particles having an average particle size of from 33 to 37 microns.
11. The flooring coating formulation of any preceding or following embodiment/feature/aspect, wherein the at least one crosslinking acrylate monomer is trimethylolpropane triacrylate, triethylene glycol diacrylate, tripropylene glycol diacrylate, or 1, 6-hexandiol diacrylate, or any combination thereof.
12. The flooring coating formulation of any preceding or following embodiment/feature/aspect, wherein the at least one polymerizable cyclic/aromatic acrylate monomer is phenylphenoxy ethyl acrylate, isobornyl methacrylate, cyclohexane dimethanol dimethacrylate, or ethoxylated bisphenol diacrylate, or any combination thereof.
13. The flooring coating formulation of any preceding or following embodiment/feature/aspect, wherein the matting agent particles comprise silica.
14. The flooring coating formulation of any preceding or following embodiment/feature/aspect, wherein the at least one reactive diluent acrylate monomer is dipropylene glycol diacrylate, isobornyl acrylate, 1,6-hexandiol diacrylate, diethylene glycol diacrylate, 1,4-butanediol diacrylate, tripropylene glycol diacrylate, or diethylene glycol diacrylate, or any combination thereof.
15. The flooring coating formulation of any preceding or following embodiment/feature/aspect, wherein the at least one fluorinated acrylate monomer is pentafluorophenyl acrylate, or pentafluorophenyl methacrylate, or any combination thereof.
16. The flooring coating formulation of any preceding or following embodiment/feature/aspect, wherein the at least one photoinitiator is methyl-2-benzoylbenzoate, 2-hydroxy-2-methyl-1-phenyl-1propanone, benzyl dimethyl ketal, 1-hydroxy-cyclohexylphenyl-ketone, or methyl benzoyl formate, or any combination thereof.
17. The flooring coating formulation of any preceding or following embodiment/feature/aspect, wherein the at least one crosslinkable oligomer comprises at least one crosslinkable aliphatic urethane acrylate oligomer, at least one crosslinkable polyester acrylate oligomer, and at least one crosslinkable self-matting oligomer.
18. The flooring coating formulation of any preceding or following embodiment/feature/aspect, wherein the at least one crosslinkable oligomer comprises at least one crosslinkable aliphatic urethane hexaacrylate oligomer having a functionality of about 6, at least one crosslinkable polyester acrylate oligomer having a functionality of about 3.5, and at least one crosslinkable self-matting oligomer having/comprising a functionality of 2.
19. The flooring coating formulation of any preceding or following embodiment/feature/aspect, wherein the a) through h) are present in the following amounts:
a) from about 3 wt % to about 18 wt % of the inorganic particles;
b) from about 2 wt % to about 20 wt % of the at least one crosslinking acrylate monomer;
c) from about 2 wt % to about 20 wt % of the at least one polymerizable cyclic/aromatic acrylate monomer;
d) from about 2 wt % to about 8 wt % of the matting agent particles which are different from a);
e) from about 2 wt % to about 20 wt % of the at least one reactive diluent monomer;
f) from about 0.5 wt % to about 4 wt % of the at least one fluorinated acrylate monomer;
g) from about 6 wt % to about 48 wt % of the at least one crosslinkable oligomer; and
h) from about 2 wt % to about 10 wt % of the at least one photoinitiator, all based on total weight of the flooring coating formulation.
20. The flooring coating formulation of any preceding or following embodiment/feature/aspect, wherein the inorganic particles are aluminum oxide particles.
21. The flooring coating formulation of any preceding or following embodiment/feature/aspect, the flooring coating formulation comprising:
a) from about 1 wt % to about 6 wt % of aluminum oxide particles having an average particle size of from 16 to 20 microns;
b) from about 1 wt % to about 6 wt % of aluminum oxide particles having an average particle size of from 23 to 27 microns;
c) from about 1 wt % to about 6 wt % of aluminum oxide particles having an average particle size of from 33 to 37 microns;
d) from about 2 wt % to about 20 wt % of at least one crosslinking acrylate monomer;
e) from about 2 wt % to about 20 wt % of at least one polymerizable cyclic/aromatic acrylate monomer;
f) from about 2 wt % to about 8 wt % of silica;
g) from about 2 wt % to about 20 wt % of at least one reactive diluent acrylate monomer;
h) from about 0.5 wt % to about 4 wt % of at least one fluorinated methacrylate monomer;
i) from about 2 wt % to about 20 wt % of at least one crosslinkable aliphatic urethane acrylate oligomer;
j) from about 2 wt % to about 20 wt % of at least one crosslinkable polyester acrylate oligomer;
k) from about 2 wt % to about 8 wt % of at least one crosslinkable self-matting oligomer; and
1) from about 2 wt % to about 10 wt % of at least one photoinitiator, all based on total weight of the flooring coating formulation.
22. The present invention further relates to a floor covering comprising a layer of cured coating, wherein the cured coating comprises a polymerized formulation of the flooring coating formulation of any preceding or following embodiment/feature/aspect.
23. The floor covering of any preceding or following embodiment/feature/aspect, where the layer is a wear layer.
24. The floor covering of any preceding or following embodiment/feature/aspect, wherein the layer of cured coating exhibits gloss in a range of from 6 to 14.
25. The floor covering of any preceding or following embodiment/feature/aspect, wherein the layer of cured coating has a durometer Shore A hardness reading of from about 80 to about 100.
26. The floor covering of any preceding or following embodiment/feature/aspect, wherein from about 70 wt % to about 90 wt % of the flooring coating formulation is crosslinked into a matrix formed from curing the flooring coating formulation to form the cured coating, based on total weight of the flooring coating formulation.
27. The floor covering of any preceding or following embodiment/feature/aspect, wherein the layer includes a bottom coat layer and a top coat layer or an outermost layer, and wherein the top coat layer or outermost layer contains the polymerized formulation.
28. The floor covering of any preceding or following embodiment/feature/aspect, wherein the bottom coat layer comprises polyvinylchloride, urethane, acrylic, melamine polyolefins or wood.
29. The floor covering of any preceding or following embodiment/feature/aspect, wherein the bottom coat layer comprises polyvinyl chloride.
30. The floor covering of any preceding or following embodiment/feature/aspect, wherein the top coat layer or outermost layer is adhered directly onto the bottom coat layer or onto an intermediate wear layer base coat adhered to the bottom coat layer.
31. The floor covering of any preceding or following embodiment/feature/aspect, wherein the layer is embossed.
32. The floor covering of any of any preceding or following embodiment/feature/aspect, wherein the floor covering is vinyl composition tile, vinyl flooring, vinyl resilient flooring, plastic panels, laminate flooring, wood panels, veneer-board panels, or composite panels with or without a print layer.

The present invention can include any combination of these various features or embodiments above and/or below as set forth in sentences and/or paragraphs. Any combination of disclosed features herein is considered part of the present invention and no limitation is intended with respect to combinable features.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. Flooring coating formulation, comprising:
a) inorganic particles;
b) at least one crosslinking acrylate monomer;
c) at least one polymerizable cyclic/aromatic acrylate monomer;
d) matting agent particles which are different from a);
e) at least one reactive diluent acrylate monomer;
f) at least one fluorinated acrylate monomer;
g) at least one crosslinkable oligomer; and
h) at least one photoinitiator.

2. The flooring coating formulation of claim 1, wherein from about 70 wt % to about 90 wt % of the coating formulation is crosslinkable into a matrix upon curing the coating formulation, based on total weight of said coating formulation.

3. The flooring coating formulation of claim 1, further comprising i) an adhesion promoter.

4. The flooring coating formulation of claim 1, wherein the inorganic particles comprise aluminum oxide, feldspar, fused silica, or recycled ground glass, or any combination thereof.

5. The flooring coating formulation of claim 1, wherein the inorganic particles are aluminum oxide.

6. The flooring coating formulation of claim 5, wherein the aluminum oxide is calcined or fused aluminum oxide.

7. The flooring coating formulation of claim 5, wherein said aluminum oxide has an average particle size of from about 10 to about 60 microns.

8. The flooring coating formulation of claim 5, wherein the aluminum oxide is present in an amount sufficient to improve wear and/or stain resistance.

9. The flooring coating formulation of claim 1, wherein the inorganic particles comprise aluminum oxide as a mixture of at least three different size fractions which differ with respect to average particle size by at least 3 microns from each other.

10. The flooring coating formulation of claim 1, wherein the inorganic particles comprise aluminum oxide as a mixture of a first size fraction of fused aluminum oxide particles having an average particle size of from 16 to 20 microns, a second size fraction of fused aluminum oxide particles having an average particle size of from 23 to 27 microns, and a third size fraction of fused aluminum oxide particles having an average particle size of from 33 to 37 microns.

11. The flooring coating formulation of claim 1, wherein the at least one crosslinking acrylate monomer is trimethylolpropane triacrylate, triethylene glycol diacrylate, tripropylene glycol diacrylate, or 1, 6-hexandiol diacrylate, or any combination thereof.

12. The flooring coating formulation of claim 1, wherein the at least one polymerizable cyclic/aromatic acrylate monomer is phenylphenoxy ethyl acrylate, isobornyl methacrylate, cyclohexane dimethanol dimethacrylate, or ethoxylated bisphenol diacrylate, or any combination thereof.

13. The flooring coating formulation of claim 1, wherein the matting agent particles comprise silica.

14. The flooring coating formulation of claim 1, wherein the at least one reactive diluent acrylate monomer is dipropylene glycol diacrylate, isobornyl acrylate, 1,6-hexandiol diacrylate, diethylene glycol diacrylate, 1,4-butanediol diacrylate, tripropylene glycol diacrylate, or diethylene glycol diacrylate, or any combination thereof

15. The flooring coating formulation of claim 1, wherein the at least one fluorinated acrylate monomer is pentafluorophenyl acrylate, or pentafluorophenyl methacrylate, or any combination thereof

16. The flooring coating formulation of claim 1, wherein the at least one photoinitiator is methyl-2-benzoylbenzoate, 2-hydroxy-2-methyl-1-phenyl-1 propanone, benzyl dimethyl ketal, 1-hydroxy-cyclohexylphenyl-ketone, or methyl benzoyl formate, or any combination thereof

17. The flooring coating formulation of claim 1, wherein the at least one crosslinkable oligomer comprises at least one crosslinkable aliphatic urethane acrylate oligomer, at least one crosslinkable polyester acrylate oligomer, and at least one crosslinkable self-matting oligomer.

18. The flooring coating formulation of claim 1, wherein the at least one crosslinkable oligomer comprises at least one crosslinkable aliphatic urethane hexaacrylate oligomer having a functionality of about 6, at least one crosslinkable polyester acrylate oligomer having a functionality of about 3.5, and at least one crosslinkable self-matting oligomer having/comprising a functionality of 2.

19. The flooring coating formulation of claim 1, wherein said a) through h) are present in the following amounts:
a) from about 3 wt % to about 18 wt % of the inorganic particles;
b) from about 2 wt % to about 20 wt % of the at least one crosslinking acrylate monomer;
c) from about 2 wt % to about 20 wt % of the at least one polymerizable cyclic/aromatic acrylate monomer;
d) from about 2 wt % to about 8 wt % of the matting agent particles which are different from a);
e) from about 2 wt % to about 20 wt % of the at least one reactive diluent monomer;
f) from about 0.5 wt % to about 4 wt % of the at least one fluorinated acrylate monomer;
g) from about 6 wt % to about 48 wt % of the at least one crosslinkable oligomer; and
h) from about 2 wt % to about 10 wt % of the at least one photoinitiator, all based on total weight of said flooring coating formulation.

20. The flooring coating formulation of claim 19, wherein the inorganic particles are aluminum oxide particles.

21. The flooring coating formulation of claim 1, said flooring coating formulation comprising:
a) from about 1 wt % to about 6 wt % of aluminum oxide particles having an average particle size of from 16 to 20 microns;
b) from about 1 wt % to about 6 wt % of aluminum oxide particles having an average particle size of from 23 to 27 microns;
c) from about 1 wt % to about 6 wt % of aluminum oxide particles having an average particle size of from 33 to 37 microns;
d) from about 2 wt % to about 20 wt % of at least one crosslinking acrylate monomer;
e) from about 2 wt % to about 20 wt % of at least one polymerizable cyclic/aromatic acrylate monomer;
f) from about 2 wt % to about 8 wt % of silica;
g) from about 2 wt % to about 20 wt % of at least one reactive diluent acrylate monomer;
h) from about 0.5 wt % to about 4 wt % of at least one fluorinated methacrylate monomer;
i) from about 2 wt % to about 20 wt % of at least one crosslinkable aliphatic urethane acrylate oligomer;
j) from about 2 wt % to about 20 wt % of at least one crosslinkable polyester acrylate oligomer;
k) from about 2 wt % to about 8 wt % of at least one crosslinkable self-matting oligomer;
and
l) from about 2 wt % to about 10 wt % of at least one photoinitiator, all based on total weight of said flooring coating formulation.

22. A floor covering comprising a layer of cured coating, wherein the cured coating comprises a polymerized formulation of said flooring coating formulation of claim 1.

23. The floor covering of claim 22, where the layer is a wear layer.

24. The floor covering of claim 22, wherein the layer of cured coating exhibits gloss in a range of from 6 to 14.

25. The floor covering of claim 22, wherein the layer of cured coating has a durometer Shore A hardness reading of from about 80 to about 100.

26. The floor covering of claim 22, wherein from about 70 wt % to about 90 wt % of the flooring coating formulation is crosslinked into a matrix formed from curing the flooring coating formulation to form the cured coating, based on total weight of said flooring coating formulation.

27. The floor covering of claim 22, wherein said layer includes a bottom coat layer and a top coat layer or an outermost layer, and wherein said top coat layer or outermost layer contains said polymerized formulation.

28. The floor covering of claim 27, wherein said bottom coat layer comprises polyvinylchloride, urethane, acrylic, melamine polyolefins or wood.

29. The floor covering of claim 27, wherein the bottom coat layer comprises polyvinyl chloride.

30. The floor covering of claim 27, wherein the top coat layer or outermost layer is adhered directly onto the bottom coat layer or onto an intermediate wear layer base coat adhered to the bottom coat layer.

31. The floor covering of claim 22, wherein the layer is embossed.

32. The floor covering of claim 1, wherein said floor covering is vinyl composition tile, vinyl flooring, vinyl resilient flooring, plastic panels, wood panels, veneer-board panels, laminate flooring, or composite panels with or without a print layer.
